(19) United States
(12) Patent Application Publication
(10) Pub. No.: US 2011/0191233 A1
(43) Pub. Date: Aug. 4, 2011

(54) Auto Substitution Collateral Management System and Method

(76) Inventors: Thomas Michael Russo, Millstone, NJ (US); Robert McGowan, Woodbury, NY (US)

(21) Appl. No.: 13/018,528

(22) Filed: Feb. 1, 2011

Related U.S. Application Data
(60) Provisional application No. 61/300,714, filed on Feb. 2, 2010.

(51) Int. Cl. G06Q 40/00

(52) U.S. Cl. 705/37

(57) ABSTRACT

An auto substitution system and method are provided for facilitating fulfillment of intraday trading requirements by implementing collateral in encumbered shells of tri party repo agreements. The method is triggered upon notification of insufficient unencumbered collateral to satisfy delivery instructions for required collateral. The method includes receiving, at an auto substitution system, a request for the required collateral upon failure to locate unencumbered required collateral. The method further includes implementing computer processing components of the auto substitution system to search for the required collateral in the encumbered shells and upon finding the required collateral, searching for replacement collateral for the required collateral. The method further includes implementing the required collateral found in the encumbered shells to fulfill delivery instructions and substituting the replacement collateral for the required collateral found in the encumbered shells.

### RELATED APPLICATIONS

This application claims priority to U.S. Provisional Application serial No. 61/300,714, filed on Feb. 2, 2010. This application also incorporates by reference commonly owned PCT Application Serial No. PCT US09/52420, filed on Jul. 31, 2009, which claims priority to U.S. Provisional Application Serial No. 61/085,563, filed on Aug. 1, 2008. This application further incorporates by reference U.S. patent application Ser. No 12/715,532, filed on Mar. 2, 2010, which claims priority to U.S. Provisional application serial 61/157,962, filed on Mar. 6, 2010.

### TECHNICAL FIELD

Embodiments of the invention are related generally to systems and methods for managing collateral involved in tri-party repurchase (repo) agreements and risk involved in the tri-party repo (TPR) market.

### BACKGROUND OF THE INVENTION

Repo agreements involve contracts to exchange securities for cash for a limited time period. The arrangement may be characterized as a loan in which title to the securities does not change hands. In the tri-party space, an independent agent bank or clearing house oversees the standard two party repo transaction. The responsibilities of the independent agent include maintaining acceptable and adequate collateral and overall maintenance of the outstanding repo trades. The TPR transactions can be overnight trades. term trades with some fixed future maturity date, or open trades, which remain in place until either one of the parties elects not to renew.

Currently, a limited number of institutions serve as intermediary clearing banks. The TPR market serves as a mechanism for financing securities inventories held by banks and dealers that make securities markets and contribute to the liquidity of those securities markets. However, despite the fact that the availability of the TPR market enhances flexibility for both dealers' and lenders, a large volume of exposure being handled by a small number of institutions creates substantial liability for dealers.

Furthermore, from an operational perspective, current market trade practices do not clearly differentiate between term, overnight, and open transactions, and therefore, clearing banks do not receive this information from their clients in a timely fashion and are forced to treat all TPR transactions similarly. Thus, using current collateral management processes, TPRs are unwound each morning when collateral is transferred from lenders to one of the existing clearing banks, with allocations beginning in the afternoon. Between the unwinding process in the morning and the allocation of new trades in the afternoon, the clearing banks are subject to substantial counterparty and market risk. In the event of a market disruption, the risk could be amplified.

Thus. a solution is needed for improved collateral management with respect to TPR transactions in order to minimize risk exposure. To facilitate participation, the solution should preferably be fully automated and incorporated in or accessible to the infrastructure of the clearing bank.

### SUMMARY OF INVENTION

Embodiments of the invention are related to an auto substitution method for facilitating fulfillment of intraday trading requirements by implementing collateral in encumbered shells of tri party repo agreements. The method may be triggered upon notification of insufficient unencumbered collateral to satisfy delivery instructions for required collateral. In one aspect of the invention, the method includes receiving, at an auto substitution system, a request for the required collateral upon failure to locate unencumbered required collateral and implementing computer processing components of the auto substitution system to perform actions in response. The actions include searching for the required collateral in the encumbered shells and upon finding the required collateral, searching for replacement collateral for the required collateral. The method further includes implementing the required collateral found in the encumbered shells to fulfill delivery instructions and substituting the replacement collateral for the required collateral found in the encumbered shells.

In a further aspect of the invention, an auto substitution method is provided for facilitating fulfillment of intraday trading requirements by implementing collateral in encumbered shells of tri party repo agreements. As set forth above, the method may be triggered upon notification of insufficient unencumbered collateral to satisfy delivery instructions for required collateral. The method includes receiving, at an auto substitution system, a request for the required collateral upon failure to locate unencumbered required collateral. Upon receipt of the request, the method includes implementing computer processing components of the auto substitution system to perform actions including searching for required collateral in the encumbered shells and upon finding the required collateral, searching for replacement collateral for the required collateral. The method further includes locating available cash upon failure to locate replacement collateral. implementing the required collateral found in the encumbered shells to fulfill delivery instructions, and substituting the available cash for the required collateral found in the encumbered shells. The method further includes dynamically scanning encumbered shells for cash upon receipt of securities and re-collateralizing the cash with the received securities.

In a further aspect of the invention, an auto substitution system is provided for facilitating fulfillment of intraday trading requirements by implementing collateral in encumbered shells of tri party repo agreements. Operation of the system is triggered by notification of insufficient unencumbered collateral to satisfy delivery instructions for required collateral. The system includes an interface for receiving a request for the required collateral upon failure to locate unencumbered required collateral and a required collateral locator module for locating the required collateral in the encumbered shells. The system further includes a replacement collateral locator module for operation upon finding the required collateral, the replacement collateral locator module including components for searching for replacement collateral for the required collateral. The system further includes an auto substitution engine implementing computer processing components for utilizing the required collateral found in the encumbered shells to fulfill delivery instructions and substituting the replacement collateral for the required collateral found in the encumbered shells.

### BRIEF DESCRIPTION OF DRAWINGS

The purpose and advantages of the present invention will be apparent to those of skill in the art from the description in conjunction with the drawings, wherein:

FIG. 1 is a block diagram illustrating an operating environment for an auto substitution system in accordance with an embodiment of the invention;

FIG. 2 is a block diagram illustrating interaction between parties to a transaction in accordance with an embodiment of the invention;

FIG. 3 is a block diagram illustrating an auto substitution system in accordance with an embodiment of the invention;

FIG. 4 is a flow chart illustrating operation of an auto substitution system in accordance with an embodiment of the invention;

FIG. 5 is a flow chart illustrating a method for seeking required collateral for auto substitution in accordance with a an embodiment of the invention;

FIG. 6 is a flow chart illustrating a method for locating replacement collateral for auto substitution in accordance with an embodiment of the invention;

FIG. 7 is a flow chart illustrating a method for auto substitution in accordance with an embodiment of the invention;

FIG. 8A is a flow chart illustrating a method for dynamic cash release in the auto substitution system in accordance with an embodiment of the invention;

FIG. 8B is a flow chart illustrating a method performed by a re-queue manager in accordance with an embodiment of the invention; and

FIG. 9 is a block diagram illustrating a computing environment for implementing a method and system in accordance with an embodiment of the invention.

### DETAILED DESCRIPTION OF PREFERRED EMBODIMENTS

Embodiments of the present invention are directed to managing collateral by implementing auto substitution for TPRs to allow dealers to access securities in TPR arrangements in order to trade and meet intraday clearing requirements. The proposed system includes a dynamic collateral substitution capability, referenced herein as auto substitution. Auto substitution enables dealers to extract required securities from encumbered shells, where a “shell” represents the requirements (amount, profile, term, rate, etc.) of a TPR deal. As will be further explained below, the auto substitution process will substitute equivalent or better quality of securities or cash ensuring that lenders are fully collateralized at all times.

The proposed auto substitution system may be incorporated within or operate in conjunction with a larger collateral management system, such as that described in U.S. Pat. No. 7,480.632 to Fudali et al., or the systems described in provisional application Serial No. 61/157,962. filed on Mar. 6, 2009, PCT Application Serial No. PCT US09/52420, filed on Jul. 31, 2009, and U.S. Provisional Application Serial No. 61/085,563, filed on Aug. 1, 2008, the disclosures of which are incorporated by reference. This application further incorporates by reference and may operate in conjunction with the system described in U.S. patent application Ser. No 12/715,532, tiled on Mar. 2, 2010, which claims priority to U.S. Provisional application serial 61/157,962, filed on Mar. 6, 2009. However, the auto-substitution system described. herein may be employed specifically for TPR collateral management activities, while the overall system operates across a larger universe of products and obligations.

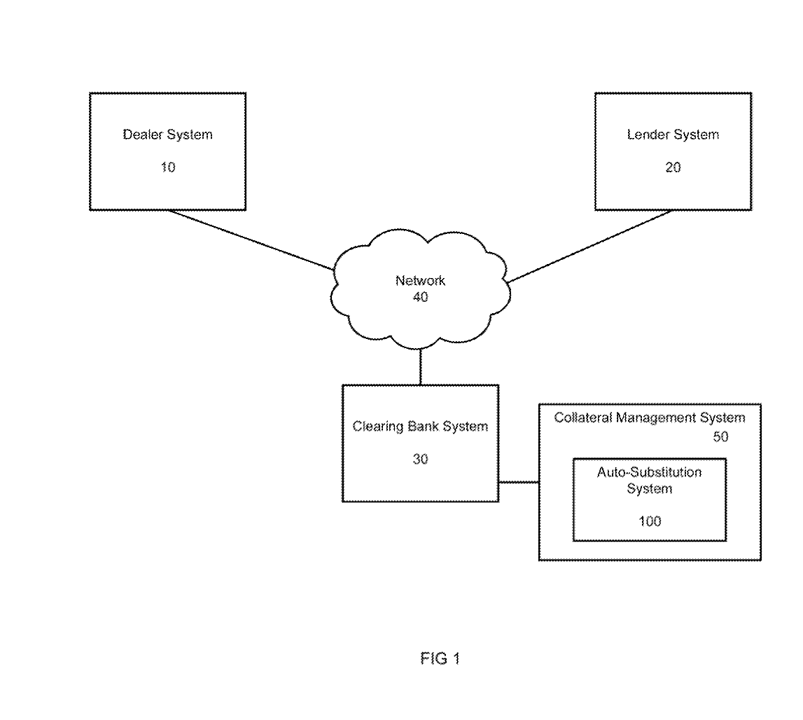

FIG. 1 is a block diagram illustrating an operating environment for an auto substitution system in accordance with an embodiment of the invention. A dealer system 10, a lender system 20, and a clearing bank system 30 may be connected over a network 40. The clearing bank system 30 may include or access a collateral management system 50. The collateral management system may include an auto substitution system 100.

The dealer system 10 represents a collateral provider system and lender systems 20 represent collateral receivers. Although only one of each system is shown, it should be understood that multiple systems of each type may be connected over the network Typically, dealer systems 10 and lender systems 20 may be required to be enrolled in the collateral management system 50 operated by the clearing bank 30 in order to participate.

The clearing bank system 30 may operate as intermediary for the purposes of TPR agreements, but further may include traditional banking services and systems. The collateral management system 50 may be incorporated in the clearing bank system 30 or may be a separate system accessible to the clearing bank system 30. Similarly, the auto substitution system 100 may be incorporated in or accessible to the collateral management system 50 and the clearing bank system 30.

Network 40 may include various networks in accordance with embodiments of the invention, including a wired or wireless local area network (LAN) and a wide area network (WAN), wireless personal area network (PAN) and other types of networks. When used in a LAN networking environment, computers may be connected to the LAN through a network interface or adapter. When used in a networking environment, computers may include a communication mechanism. Communication devices may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

The collateral management system 50 allocates securities as collateral from participant long boxes and collateral accounts to lender collateral accounts. Eligibility selection components may be available to both borrowers and lenders and may provide the opportunity for both counterparties to adjust eligibility settings. The eligibility selection components may allow lenders to specify eligibility criteria by detailing the assets that they will accept. An interface may be provided to allow lenders to designate eligibility at a product level, so that certain assets may be considered ineligible across all participants. The eligibility selection components may provide lenders with self-service capability allowing them to set up eligibility schedules. Alternatively or additionally, an interface may be provided through the financial institution at an administrative level in order to allow setup on behalf of the participant. Additionally, the eligibility selection components allow borrowers to specify the assets that they would like to be considered as ineligible. Borrowers may designate individual assets or an entire class of instruments as ineligible or as unavailable to specific lenders. Both the borrowers and the lenders will be able to independently view the actual eligibility schedule that is in force, the pending changes, and for the pending changes, an indication of when they will be effective. A web and a graphical user interface preferably allows participants to view positions via the web and to input and manage the eligibility data across all collateral management products. From the user interface, the user may be able to make adjustments to eligibility criteria definitions during the trading day.

An interactive ranking engine may allow borrowers, who are the collateral providers, to use collateral types as the basis for assigning a relative quality of collateral or asset class priority. In preferred embodiments, borrowers have the capability to be able to update their priority of assets intraday, and to allow multiple settings to be changed through the day. Thus, the borrower is successfully able to specify its own order for sorting the assets, thereby overriding any existing system default order.

Lenders, who are the collateral receivers, use the collateral type to define eligibility and may also associate concentration limits against them. Borrowers may be provided with the ability to rank or prioritize assets from ‘Allocate first’ to ‘Allocate last’. The Borrower will typically want to allocate the lowest quality asset it has to lenders first and then move up the scale. The system evaluates each asset to ensure that the strictest of the limits is not broken and to ensure that none of these limits is broken individually. For example, a set of lender accounts could be part of a cross account group concentration limit. Once the group of accounts has reached its limit, then no more collateral can be allocated even though the individual accounts' concentration limits have not been reached. An additional check involves calculation of the amount of collateral that can be allocated.

The eligibility criteria will be specified using a rules based approach similar to the manner in which email users specify rules for managing incoming email. In a preferred embodiment, the rules are configured in a tree format, starting with an asset type, and descending multiple levels, with multiple forks en route, as further granularity is specified. A similar tree structure may also be used to specify concentration limits and haircuts. The rules based approach allows the participants to specify exactly what assets it will accept, without having to separately call out exclusions.

The system 100 leverages a robust technical architecture to allow for completion of trades in seconds. While trades requiring auto substitution may take several seconds longer than trades executed in the existing timeframe without this capability, the total time will be well within market tolerances. Furthermore, clearance and TPR may operate on a shared platform that allows for efficient review of trading and repo collateral activity in order to further facilitate timely substitutions.

Embodiments of the system are configured to leverage a morning window prior to market opening. Currently, dealers instruct the vast majority of daily settlement activity prior to Fed wire open. Therefore, the clearing bank can begin to execute auto substitution before the market opens without impacting clearance activity. However, various processes implemented by the auto substitution system may run periodically or continuously or when triggered throughout and after termination of the trading clay.

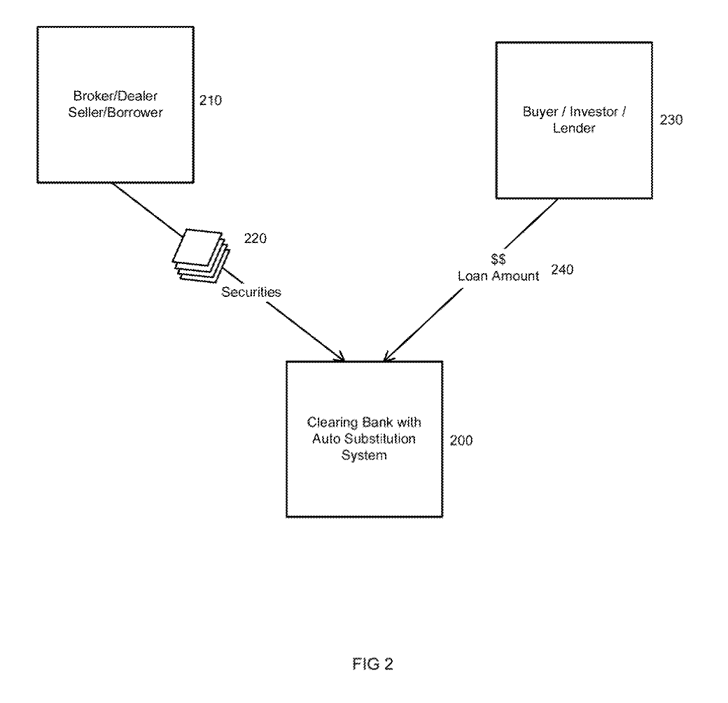

FIG. 2 is a block diagram illustrating interaction between parties to a transaction in accordance with an embodiment of the invention. As set forth above, a repo agreement occurs between two parties. One party agrees to loan or deliver securities and thus provides them in exchange for receiving cash from the other party. A tri-party repo introduces an intermediary to manage the exchange. FIG. 2 illustrates the delivering party 210 referenced as a broker/dealer/seller/borrower 210 delivering securities 220 to an intermediary 200, which is preferably a clearing bank implementing an auto substitution system. A buyer/investor/lender 230 delivers a loan amount 230 to the clearing bank 200 in exchange for the securities 220. At a future date, the broker/dealer/seller/borrower 210 will return the cash and retrieve the securities 220 temporarily held by the buyer/investor/lender 230.

The clearing bank 200 operates as administrator of the transaction and performs collateral allocation. As part of a TPR agreement, the three parties agree to a collateral management service agreement that includes an eligible collateral profile that enables the buyer to define acceptable risk in terms of collateral. In other words, the buyer defines the collateral and the margin required on the asset class that it is prepared to hold against cash. In embodiments of the invention, the clearing bank offers collateral eligibility filters to facilitate the creation of an eligible collateral profile.

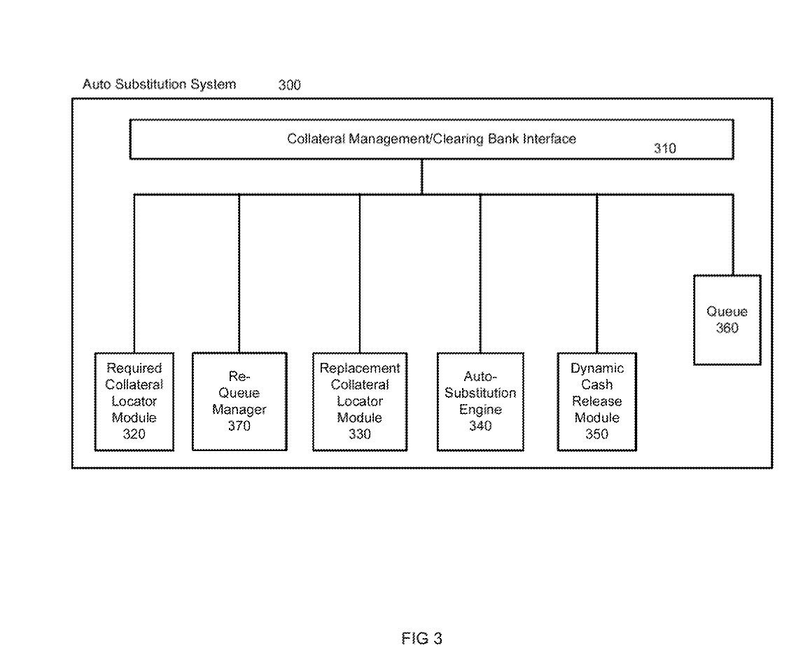

FIG. 3 is a block diagram illustrating an auto substitution system 300 in accordance with an embodiment of the invention. Three primary substitution volume mitigants that can be leveraged by the displayed auto substitution system 300 include: (1) the majority of deliveries can be offset with receives, typically before market open; (2) most dealers have a pool of unencumbered collateral not financed in TPR that can be leveraged; and (3) CUSIP (cash temporarily substitution securities as collateral) can be leveraged to ensure timely release of collateral.

The auto-substitution system 300 may include a collateral management/clearing bank interface 310 that receives information from and delivers information to external or integrated systems. Operational components that receive and deliver information through the interface 310 may include a required collateral locator module 320, a replacement collateral locator module 330, an auto-substitution engine 340, and a dynamic cash release module 350. These components may be or include both software and/or hardware components and further may be configured in any manner suitable for accomplishing the functions explained herein. A queue 360 is accessible to the aforementioned components and may be managed by a re-queue manager 370.

The required collateral locator module 320 is provided to locate required collateral for use in daily trading activity. Operation of this module may be triggered in order to release collateral to process received trading requests and may be triggered prior to the beginning of the trading day. The required collateral represents collateral required to execute the trading requests. While the clearing hank will first attempt to locate unencumbered collateral, if the unencumbered collateral cannot be located from other sources, the required collateral locator module 320 will be utilized to locate suitable encumbered collateral locked in encumbered TPR shells.

The replacement collateral locator module 330 operates upon location of the required collateral by the required collateral locator module 320. If the required collateral locator module 320 does not find the required collateral. the replacement collateral locator module 330 has no need to operate. The replacement collateral locator module 330 operates to ensure that TPR agreements remain fully collateralized at all times. Thus, the replacement collateral locator module 330 attempts to locate collateral of adequate quality to substitute into the TPR shell. The replacement collateral locator module 330 may seek the replacement collateral in a long box location specified by the system participants. The long box location may store free unencumbered collateral as well as cash. In the event that the replacement collateral locator module 330 cannot locate collateral of adequate quality in the pre-specified locations to substitute into the TPR shell, the replacement collateral locator module 330 may attempt to locate adequate cash in the system participant's long box to temporarily collateralize the TPR. As will be further explained below, if the replacement collateral locator module 330 does not find collateral of adequate quality or sufficient cash in the long box for substitution into the TPR shell, the required collateral cannot be extracted from the TPR shell. Instead, the trading request will be placed in the queue 360, which will be auto-scanned by the re-queue manager 370, as will he further described below, until the collateral is available.

The auto substitution engine 340 functions to ensure that the required collateral is provided for the trade request and that the replacement collateral is substituted into the TPR shell so that the TPR agreement remains fully collateralized.

The dynamic cash release module 350 is provided to facilitate the release of cash locked in the TPR shells. Because the replacement collateral locator module 330 replaces required collateral with cash when collateral of sufficient quality cannot be located as a replacement, there is a need to scan the shells in order to re-collateralize the cash with securities. The dynamic cash release module 350 performs this function.

The queue 360 is provided to enable trade requests to await receipt of a sufficient quality of required collateral or replacement collateral. When either the required collateral locator module 320 or the replacement collateral locator module 330 fails to find sufficient required collateral or replacement collateral, the request can be put in the queue 360. Items in the queue 360 will periodically be scanned and compared to newly received collateral by the re-queue manager 370 so that the appropriate action can be taken to extract required collateral and substitute replacement collateral. The re-queue manager 370 may operate at regular intervals throughout the trading day.

In evaluating both required and replacement collateral, the auto substitution system preferably evaluates the eligibility requirements as described above that may have been pre-designated by borrowers and/or lenders.

The auto substitution system 300 may additionally include or access components for handling General Collateral Finance (GCF) Repos. The system may implement a combination of auto substitution and secured credit line functions. Security level auto substitution can be used to facilitate the daily maturing of GCF and preserve the collateralization of the end lender. The clearing bank system may perform securities or cash substitution with the end lender to release required collateral, potentially providing secured financing via a secured credit line. The clearing bank returns the required securities to FICC. FICC returns cash to the clearing bank system, offsetting the secured credit line extension. Finally, the clearing bank system regularly reviews available collateral to replace cash with collateral in a non maturing repo. A separate GCF handling module may be incorporated in or accessible to the auto substitution system in order to facilitate the performance of the above-described steps.

A web and graphical user interface may be provided through the auto substitution or collateral management system to allow participants to view, input, and manage positions via the web. Such an interface is more fully described in U.S. patent application Ser. No. 12/715,532, which is incorporated herein by reference. The interface may be accessed from or integrated with the auto substitution system. From the user interface. the dealers may be able to select from a set of collateral prioritization parameters in order to direct the auto substitution system to optimize collateral for TPR loans.

Through the interface or through a system representative, dealers may be able to initiate a full optimization at the end of the day to ensure the most efficient use of collateral. In preferred embodiments. dealers also have real time access to their accounts with the ability to monitor loan composition. Additionally, lenders also have access to real time reporting capabilities through the user interface.

In embodiments of the invention, users will also have access to real-time self-service reporting and inquiry management. So that client service representatives may be fully utilized, the platform may provide these representatives with a remote desktop capability so that the representatives can see the client interface. The user interface is designed to enable client initiation of transactions and simplified viewing of activity.

In terms of performance, the disclosed system is configured to have superior high- speed application performance, flexibility and scalability, and will perform many functions in real-time. In summary, the disclosed platform includes an improved user interface, advanced reporting capabilities, minimal manual Processes, and enhanced automated workflow. Interfaces are also provided between the system and other internal and third-party utilities.

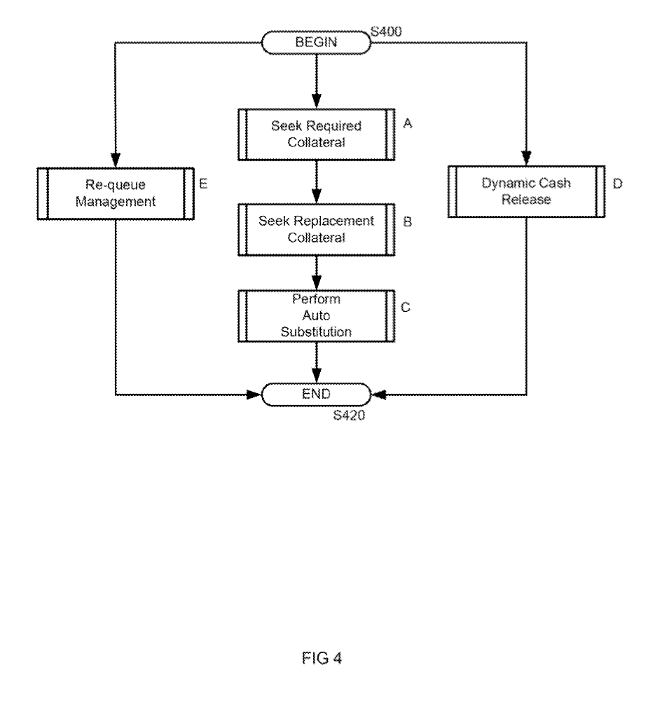

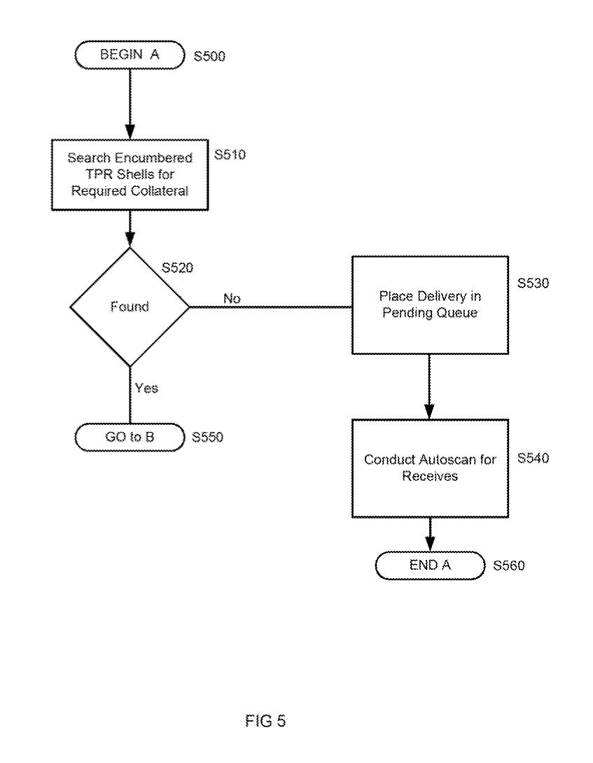

FIG. 4 is a flow chart illustrating operation of an auto substitution system in accordance with an embodiment of the invention. The method begins in S400. Prior to the start of the method, a collateral management system of the clearing bank may receive trading instructions. The majority of these instructions may be received prior to the opening of the market. The clearing bank attempts to manage collateral to fill the delivery instructions. The initial management step typically examines available and unencumbered collateral or performs matching with pending receivables. If the collateral is available, the collateral management system performs allocation and the process ends. However, if the initial matching fails, the auto substitution system operates to perform auto substitution. Operation of the auto substitution system may include processes A-E as shown. Process A seeks required collateral. Process B seeks replacement collateral, and Process C performs auto substitution. Process D can run concurrently to perform dynamic cash release. Process E can also run concurrently for queue management. The method ends in S420. Each of these processes will be described in greater detail below with respect to FIGS. 5-8.

FIG. 5 is a flow chart illustrating a method for seeking required collateral for auto substitution in accordance with an embodiment of the invention. Process A begins in S500 and the required collateral locator module searches encumbered TPR shells for required collateral in S510. If the required collateral is found in S520, control passes to the replacement collateral locator module and Process B in S550. If the required collateral is not found in S520, the method proceeds to S530 to place the delivery in the queue. In S540, the system activates auto-scanning capabilities to match items in the queue with receives. The auto-scanning is performed in Process E by the re-queue manager and may continue to operate periodically at regular intervals throughout the trading day. While S540 is shown in a specific sequential order, it may alternatively occur in a different process, in a different order, or may take place continuously during operation of the auto-substitution system. The scanning process may, for example, be triggered upon release of each new security. If the required collateral locator module does not find collateral, the process ends in 5560 and no search for replacement collateral is conducted.

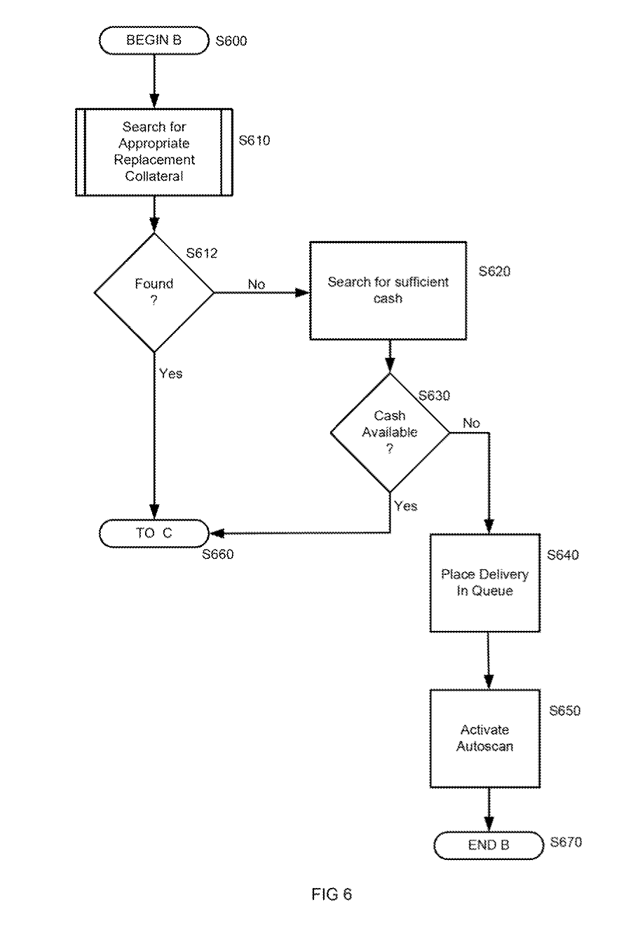

FIG. 6 is a flow chart illustrating a method for locating replacement collateral for auto substitution in accordance with an embodiment of the invention. The process begins in S600 and the replacement collateral locator module searches for replacement collateral in S610. The search for replacement collateral may be conducted on locations in a long box which are preferably pre-defined by system participants. To be qualified replacement collateral, the collateral must be of equal or better quality than the collateral being replaced. If qualified replacement collateral is found in S612, then control passes to the auto substitution engine in S660. If qualified replacement collateral is not found in S612, the system searches for sufficient replacement cash in S620. If the cash is available in S630, the system passes control to the auto-substitution system in S660, which subsequently replaces the required collateral with the replacement cash. If cash is not available in S630, the system places the delivery in the queue in S640 and activates auto-scanning 650. which is performed by the re-queue manager in process E, so that the queue will be scanned when additional securities and/or cash are received. As set forth above, the auto scanning may occur in a different sequence and further may occur continuously or periodically during operation of the auto substitution system. The scanning process may alternatively be triggered by receipt of each new security. The process ends in S670.

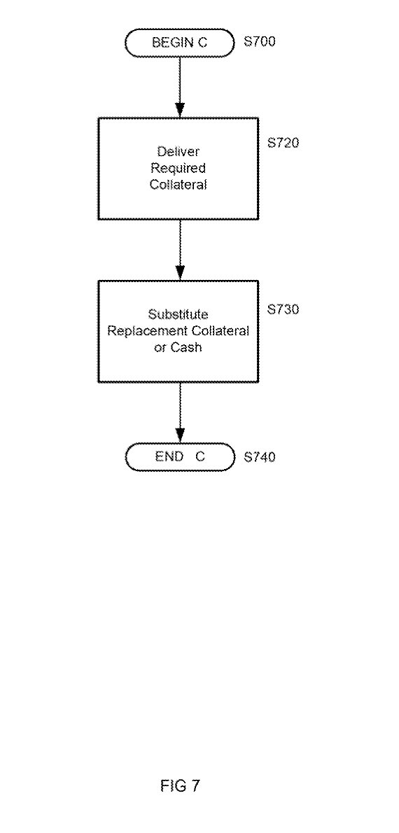

FIG. 7 is a flow chart illustrating a method for auto substitution in accordance with an embodiment of the invention. The method begins in S700 and the auto substitution engine delivers required collateral in S710. In S720, the auto-substitution engine substitutes replacement collateral or cash for the required collateral. The process ends in S730.

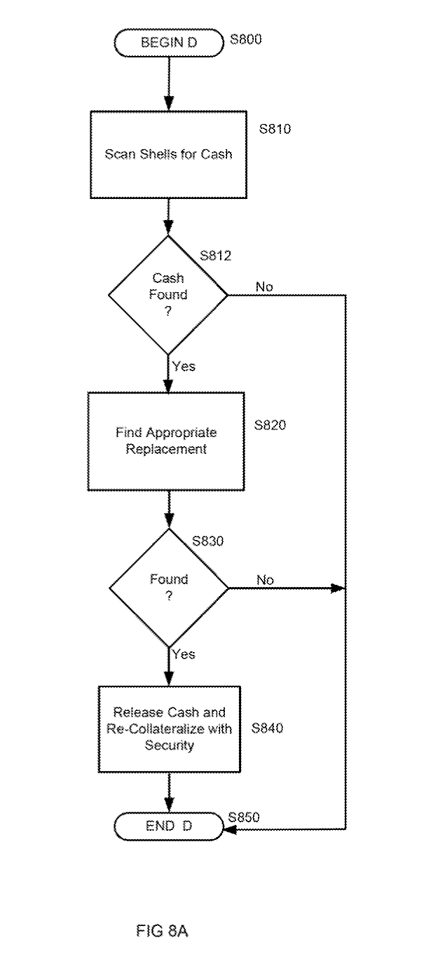

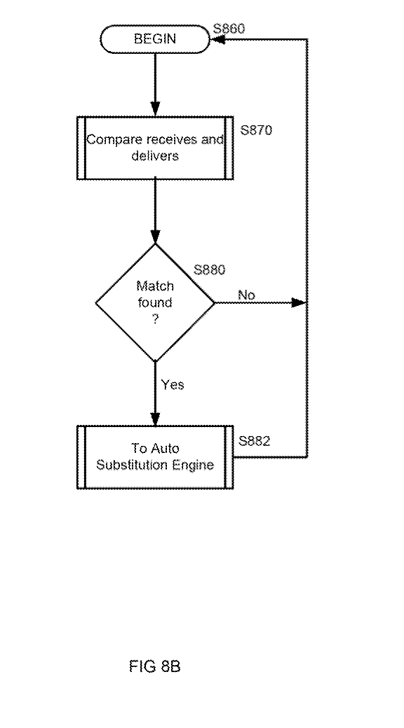

FIG. 8A is a flow chart illustrating a method for dynamic cash release in the auto substitution system in accordance with an embodiment of the invention. The process begins in S810 and the dynamic cash release module scans encumbered TPR shells for cash in S810. If cash is found in S812, the dynamic cash release module looks for an appropriate replacement for the cash in S820. If an appropriate replacement is found in S830, the dynamic cash release module releases the cash and re-collateralizes the TPR with a security as the appropriate replacement. The process ends in S850. The dynamic cash release process may be triggered upon receipt of each new security.

FIG. 8B is a flow chart illustrating a method for re-queue management in accordance with process E as performed by the above-described re-queue manager. The process begins in S860 and the re-queue manager compares a list of receives with deliveries in the queue in S870 to look for matches. To make the comparison, the re-queue manager scans the queue for transactions that have been previously attempted to be settled, it then checks to see if enough available positions have been received in this issue so that the item can be directly processed for settlement. In embodiments of the invention, if immediate settlement is not possible, the item may be re-sent to the auto substitution system and if suitable collateral cannot be found, it will be returned to the queue.

As set forth above, a match is found when collateral of the necessary quality is received. The quality should be equal to or greater than the quality of the collateral being replaced. If a match is found in S880. control is passed to the auto-substitution engine in S882. If a match is not found in S880, the process repeats. As set forth above, if the transaction cannot be settled immediately with a match that is found, auto substitution may be attempted again and the process may repeat if the item is returned to the queue. Even if a match is found in S880, the process will repeat within system parameters. For example. the system may discontinue the process if the queue is empty, if certain time constraints exist and have been triggered, or if a pre-set number of execution cycles has been reached. However, it is not necessary for the system to implement constraints and it is possible for process E to execute continuously.

The methods illustrated above with reference to FIGS. 4-8 may begin prior to fed wire opening, for example between 4AM and 8:30AM. However, the auto substitution may continue throughout intraday activity between approximately 8:30 AM and 3PM or throughout the trading day. Final optimization procedures may occur during end of day processing between approximately 3PM and 6PM.

The process is illustrated with respect to a single item of collateral. However, it should he understood that the process is capable of executing multiple cycles in order to cover all required deliveries with collateral. Each time a cycle ends, the system proceeds to another delivery instruction for fulfillment until no delivery instructions remain. Furthermore, with respect to new securities received, auto substitution logic dynamically scans shells to release cash and re-collateralize with securities. Thus an additional step is executed for revisiting cash substitutes in order to re-collateralize. This step may be performed by the dynamic cash release manager described above.

In the event that a pending receive has been implemented to support a pending delivery and the receive is not received, the system has the capability to cancel the linkage and leverage auto substitution to attempt a complete delivery.

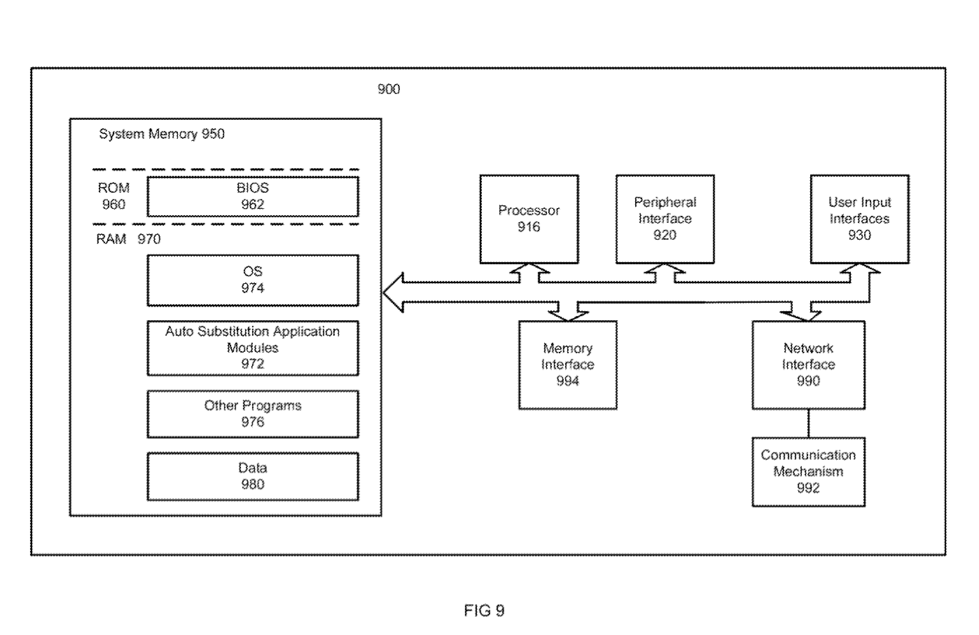

FIG. 9 is a block diagram illustrating a computing system 900 implementing auto substitution components in accordance with an embodiment of the invention. This configuration is merely exemplary and should not be construed as limiting. It is likely that multiple computing systems or devices will be utilized to implement the method and system in accordance with embodiments of the invention. The computing system 900 may include a processing unit 910, a peripheral interface 920, a user input interface 930, a system bus 940, a system memory 950, a network interface 990, a connected communication device 992, and a memory interface 994. The system bus 940 may be provided for coupling the various system components.

Computers typically include a variety of computer readable media that can form part of the system memory and be read by the processing unit. By way of example, and not limitation, computer readable media may comprise computer storage media and communication media. The system memory 950 may include computer storage media in the form of volatile and/or nonvolatile memory such as read only memory (ROM) 960 and random access memory (RAM) 970.

A basic input/output system (BIOS) 962, containing the basic routines that help to transfer information between elements, such as during start-up, is typically stored in ROM 960. RAM 970 typically contains data and/or program modules that are immediately accessible to and/or presently being operated on by processing Unit. The data or program modules may include an operating system 974, auto substitution application modules 972, other program modules 976, and program data 980. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Macintosh™® operating system, the Apache™ operating system, an OpenStep™ operating system or another operating system of platform.

At a minimum, the memory 950 includes at least one set of instructions that is either permanently or temporarily stored. The processor 910 executes the instructions that are stored in order to process data. The set of instructions may include various instructions that perform a particular task or tasks, such as those shown in the appended flowcharts. Such a set of instructions for performing a particular task may be characterized as a program, software program, software, engine, module, component, mechanism, or tool. The auto substitution application modules 972 may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be convened to machine language using a compiler, assembler, or interpreter. The machine language may be binary coded machine instructions specific to a particular computer. Illustratively, the programming language used may include assembly language, Ada, APL, Basic, C, C++, COBOL, dBase, Forth, FORTRAN, Java, Modula-2. Pascal, Prolog, REXX, and/or JavaScript for example. In embodiments of the invention, Ab Initio™ software is implemented and structured query language (SQL) is implemented for coding. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, tiles or other data may be decrypted using a suitable decryption module, for example.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment include, but are not limited to, paper, paper transparencies, a compact disk, a DVD, an integrated circuit, a hard disk, a floppy disk, an optical disk, a magnetic tape, a RAM, a ROM, a PROM, a EPROM. a wire, a cable, a fiber, communications channel, a satellite transmissions or other remote transmission, as well as any other medium or source of data that may be read by the processors of the invention. The storage media arc typically connected to the system bus through a removable or non-removable memory interface

Further, the memory or memories used in the processing machine that implements the invention may be in any of a wide variety of forms to allow the memory to hold instructions. data, or other information, as is desired. Thus, the memory might be in the form of a database to hold data. The database might use any desired arrangement of files such as a flat file arrangement or a relational database arrangement, for example.

The processing unit 910 that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

A user may enter commands and information into the computer through a user interface 930 that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices may also be connected to the system bus via an interface 920. In addition to display devices, computers may also include other peripheral output devices, which may be connected through an output peripheral interface. The computers implementing the invention may operate in a networked environment using logical connections to one or more. remote computers, the remote computers typically including many or all of the elements described above.

Thus, in the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

Various networks may be implemented in accordance with embodiments of the invention. These networks may include any of those described above with reference to FIG. 1. Although many other internal components of the computer are not shown, those of ordinary skill in the art. will appreciate that such components and the interconnections are well known. Accordingly, additional details concerning the internal construction of the computer need not be disclosed in connection with the present invention.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed. The instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Those skilled in the art will appreciate that the invention may be practiced with various computer system configurations, including hand-held wireless devices such as mobile phones or PDAs, multiprocessor systems, microprocessor-based or programmable consumer electronics. minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

Although the aforementioned components are shown as discrete modules, each of the modules may alternatively be integrated with one another. If the modules are discrete, multiple modules may operate cooperatively as will be further explained below.

The provided system and method ensure that lenders are fully collateralized at all times and attempts to minimize the use of cash. Auto substitution will allow timely available of securities to meet delivery commitments while keeping lenders collateralized.

While particular embodiments of the invention have been illustrated and described in detail herein, it should be understood that various changes and modifications might be made to the invention without departing from the scope and intent of the invention.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations.

What is claimed is:

1. An auto substitution method for facilitating fulfillment of intraday trading requirements by implementing collateral in encumbered shells of tri party repo agreements, the method triggered upon notification of insufficient unencumbered collateral to satisfy delivery instructions for required collateral, the method comprising:
receiving, at an auto substitution system, a request for the required collateral upon failure to locate unencumbered required collateral; and
implementing computer processing components of the auto substitution system to perform actions including,
searching for the required collateral in the encumbered shells,
upon finding the required collateral, searching for replacement collateral for the required collateral,
implementing the required collateral found in the encumbered shells to fulfill delivery instructions, and
substituting the replacement collateral for the required collateral found in the encumbered shells.

2. The method of claim 1, further comprising storing the delivered request in a queue if the required collateral is not located in the encumbered shells.

3. The method of claim 2, further comprising automatically checking for the delivered requests in the queue upon receipt of additional securities or cash to determine if the required collateral is available.

4. The method of claim 1, further comprising searching for cash if the replacement collateral cannot be located.

5. The method of claim 4, further comprising using the cash for substitution with the required collateral instead of using replacement collateral.

6. The method of claim 5, further comprising dynamically scanning the encumbered shells to release cash upon receipt of additional securities.

7. The method of claim 4, further comprising placing the delivered request in a queue if the cash cannot be located.

8. The method of claim 7, further comprising automatically scanning the queue for the delivered requests in the queue upon receipt of additional securities to determine if replacement collateral is available.

9. The method of claim 1, wherein the replacement collateral is of a quality equal to or higher than the quality of the required collateral.

10. The method of claim 1, wherein operation of the auto substitution system is triggered prior to market opening.

11. An auto substitution method for facilitating fulfillment of intraday trading requirements by implementing collateral in encumbered shells of tri party repo agreements, the method triggered upon notification of insufficient unencumbered collateral to satisfy delivery instructions for required collateral, the method comprising:
receiving, at an auto substitution system, a request for the required collateral upon failure to locate unencumbered required collateral; and
implementing computer processing components of the auto substitution system to perform actions including,
searching for the required collateral in the encumbered shells,
upon finding the required collateral, searching for replacement collateral for the required collateral,
locating available cash upon failure to locate replacement collateral,
implementing the required collateral found in the encumbered shells to fulfill delivery instructions;
substituting the available cash for the required collateral found in the encumbered shells; and
dynamically scanning encumbered shells, upon receipt of securities, for cash and re-collateralizing the cash with the received securities.

12. The method of claim 11, further comprising substituting the replacement collateral for the required collateral found in the encumbered shells if the replacement collateral is found.

13. The method of claim 11. further comprising storing the delivered request in a queue if the required collateral is not located in the encumbered shells.

14. The method of claim 13, further comprising automatically checking for the delivered requests in the queue upon receipt of additional securities or cash to determine if the required collateral is available.

15. The method of claim 11, further comprising placing the delivered request in a queue if the cash cannot be located.

16. The method of claim 15, further comprising automatically checking for the delivered requests in the queue upon receipt of additional securities or cash to determine if the required collateral is available.

17. The method of claim 11, wherein the replacement collateral is of a quality equal to or higher than the quality of the required collateral.

18. The method of claim 11, wherein operation of the auto substitution system is triggered prior to market opening.

19. An auto substitution system for facilitating fulfillment of intraday trading requirements by implementing collateral in encumbered shells of tri party repo agreements, operation of the system triggered by notification of insufficient unencumbered collateral to satisfy delivery instructions for required collateral, the system comprising:
an interface for receiving a request for the required collateral upon failure to locate unencumbered required collateral;
a required collateral locator module for locating the required collateral in the encumbered shells;
a replacement collateral locator module for operation upon finding the required collateral, the replacement collateral locator module including components for searching for replacement collateral for the required collateral; and
an auto substitution engine implementing computer processing components for utilizing the required collateral found in the encumbered shells to fulfill delivery instructions and substituting the replacement collateral for the required collateral found in the encumbered shells.

20. The system of claim 19, further comprising a queue for storing the delivered request if the required collateral is not located in the encumbered shells.

21. The system of claim 20, further comprising an auto scanning module for automatically checking for the delivered requests in the queue upon receipt of additional securities or cash to determine if the required collateral is available.

22. The system of claim 19, wherein the replacement collateral locator module searches for cash if the replacement collateral cannot be located.

23. The system of claim 22, further comprising using the cash for substitution with the required collateral instead of using replacement collateral.

24. The system of claim 23, further comprising a dynamic cash release module for dynamically scanning the encumbered shells to release cash upon receipt of additional securities.

25. The system of claim 24, further comprising a queue for storing the delivered request if the cash cannot be located.

26. The system of claim 25, further comprising an automatic scanning module for scanning the queue for the delivered requests in the queue upon receipt of additional securities to determine if the replacement collateral is available.

27. The system of claim 19, wherein the replacement collateral is of a quality equal to or higher than the quality of the required collateral.

28. The system of claim 19, wherein operation of the auto substitution system is triggered prior to market opening.
